(19) United States
(12) Patent Application Publication
(10) Pub. No.: US 2018/0056728 A1
(43) Pub. Date: Mar. 1, 2018

(54) Pneumatic Tire

(71) Applicant: The Yokohama Rubber Co., LTD., Minato-ku, Tokyo (JP)

(72) Inventor: Takahiro Yamakawa, Hiratsuka-shi, Kanagawa (JP)

(21) Appl. No.: 15/556,286

(22) PCT Filed: Feb. 18, 2016
(86) PCT No.: PCT/JP2016/054706

§ 371 Date: Sep. 6, 2017

(30) Foreign Application Priority Data
Mar. 6, 2015 (JP) 2015-044534

(51) Int. Cl. B60C 11/03

(52) U.S. Cl. CPC B60C 11/0316; B60C 2011/0369; B60C 2011/0372

(57) ABSTRACT

A pneumatic tire includes inner land portions, formed between a center main groove and outer main grooves on both sides of the center main groove, which are divided into blocks by sub-grooves. A pair of the sub-grooves positioned on both sides of the center main groove is inclined in the same direction with respect to the tire width direction, disposed such that openings on the center main groove side overlap in the tire circumferential direction, and the circumferential components of the sub-grooves are continuous throughout the tire circumference. A groove width of the sub-grooves changes at a middle portion in the length direction such that the sub-grooves include a narrow width section positioned on the outer main groove side and have a groove width W1 that is relatively small, and a wide section positioned on the center main groove side and having a groove width W2 that is relatively large.

### TECHNICAL FIELD

The present technology relates to a pneumatic tire, and particularly relates to a pneumatic tire whereby good steering stability performance on wet road surfaces and good wear resistance performance can be achieved in a well-balanced manner.

### BACKGROUND ART

Typically, pneumatic tires used primarily on light trucks and the like are primarily used for local travel and are subjected to repeated stop and go traveling at low to medium speeds. As such, there tends to be a demand for superior steering stability performance and superior uneven wear resistance performance from such pneumatic tires. Additionally, such pneumatic tires need to be able to deal with various road surface conditions, and suppress noise such as pass-by noise and the like.

As such, for example, Japanese Patent No. 5590267B describes a pneumatic tire wherein a plurality of rows of land portions, partitioned by a plurality of circumferential main grooves extending in a tire circumferential direction, are divided into a plurality of blocks by a plurality of subsidiary grooves extending in a tire width direction. In this pneumatic tire, a groove width at a middle portion in a length direction is changed such that each of the sub-grooves includes a wide section with a relatively larger groove width and a narrow width section with a relatively smaller groove width. Additionally, a sipe that connects the narrow width section to a specific location of the wide section is provided in each block. Moreover, a relationship between a width W1 of the wide section and a width W2 of the narrow width section and a relationship between a length L1 of the wide section and a length L2 of the narrow width section are set in a specific range. As a result, it is proposed that good steering stability performance, uneven wear resistance performance, wet performance, and noise performance are achieved in a compatible manner.

However, in recent years, particularly when using pneumatic tires in developing countries and the like, it is expected that pneumatic tires will frequently be used in a heavily loaded state or for travel on wet road surfaces. In particular, when in a heavily loaded state, the load on the blocks increases and, consequently, not only is wear more likely to occur in the entire tire but, also, there is a tendency for the groove volume to decrease due to the blocks deforming and the grooves collapsing, which leads to declines in drainage performance. As such, there is a problem of insufficient wear resistance performance and wet performance in pneumatic tires such as that described above. Thus, there is a need to add superior wear resistance performance to the performance factors described above and, also, to further enhance the steering stability performance on wet road surfaces (wet performance).

### SUMMARY

The present technology provides a pneumatic tire whereby good steering stability performance on wet road surfaces and good wear resistance performance can be achieved in a well-balanced manner.

A pneumatic tire of the present technology includes one center main groove extending in a tire circumferential direction on a tire equator of a tread portion; one outer main groove extending in the tire circumferential direction on both sides in a tire width direction of the center main groove; inner land portions formed partitioned between the center main groove and the outer main grooves; and a plurality of sub-grooves formed at an interval in the tire circumferential direction and extending in the inner land portions in the tire width direction, for which a first end communicates with the center main groove and a second end communicates with the outer main groove; wherein the inner land portions are divided into a plurality of blocks by the plurality of sub-grooves. In such a pneumatic tire, a pair of the sub-grooves positioned on both sides of the center main groove is inclined in a same direction with respect to the tire width direction, and disposed such that openings on a center main groove side at least partially overlap in the tire circumferential direction; the sub-grooves are disposed such that circumferential components of the sub-grooves are continuous throughout an entire circumference of the tire; a groove width of each of the sub-grooves changes at a middle portion in a length direction of the sub-grooves such that each of the sub-grooves includes a narrow width section positioned on an outer main groove side and having a groove width W1 that is relatively small, and a wide section positioned on the center main groove side and having a groove width W2 that is relatively large; and a sipe is formed in each block that connects a point farthest to a narrow width section side of the wide section to the narrow width section.

With the present technology, the pair of sub-grooves positioned on both sides of the center main groove is inclined in the same direction with respect to the tire width direction, and is disposed such that the openings on the center main groove side at least partially overlap in the tire circumferential direction. As such, the pair of sub-grooves adjacent across the center main groove are substantially continuous and, as a result, the flow of water passing through the sub-grooves is excellent. Thus, drainage performance can be enhanced and wet performance can be enhanced. Additionally, drainage performance can be enhanced and, as a result, wet performance can be enhanced due to the fact that the circumferential components of the sub-grooves are continuous throughout the entire circumference of the tire. Moreover, each of the sub-grooves includes the narrow width section on the outer main groove side and the wide section on the center main groove side. As a result, drainage performance can be enhanced due to the fact that the wide section is present on the center main groove side and, at the same time, declines in block rigidity can be suppressed due to the narrow width section and, thus, wear resistance can be enhanced. Furthermore, by providing the sipe as described above, drainage performance of the sipe can be obtained and, at the same time, block rigidity can be made appropriate, which is beneficial to the achieving of both good wet performance and wear resistance in a compatible manner. Note that, in the present technology, the circumferential components of the sub-grooves are circumferential direction components of the sub-grooves obtained by projecting the sub-grooves in the tire width direction.

In the present technology, it is preferable that an angle of inclination of the sub-grooves with respect to the tire width direction is from 10° to 50°. By configuring the angle of inclination of the sub-grooves in this manner, corner portions of the blocks where the sub-grooves and the center main groove or the outer main grooves communicate can be prevented from becoming excessively acute, which is beneficial to the enhancing of wear resistance. Note that the angle of inclination is measured from the center line of each of the sub-grooves.

In the present technology, it is preferable that a groove depth of the narrow width section is shallow on the wide section side and deep on the outer main groove side. By configuring the groove depth of the sub-grooves in this manner, rigidity at the portions where the groove depth is shallow is increased, which is beneficial to the enhancing of wear resistance, and superior drainage performance can be obtained at the portions where the groove depth is deep. Thus, it is possible to achieve these performance factors in a well-balanced manner.

In this case, it is preferable that a ratio d1a/d1b of a groove depth d1a on the side of the wide section of the narrow width section to a groove depth d1b on the side of the outer main groove of the narrow width section is in a range from 0.3 to 0.7. By configuring the groove depth in this manner, it is possible to more effectively obtain the effects of achieving good wet performance and wear resistance performance in a compatible manner.

In the present technology, it is preferable that a proportion of a total of groove widths of the center main groove and the outer main grooves with respect to a ground contact width is from 13% to 23%. By configuring the total width of the main grooves (the center main groove and the outer main grooves) in this manner, block width is secured, sufficient block rigidity is obtained, and wear resistance performance can be enhanced and, at the same time, groove volume is secured and sufficient drainage performance can be obtained, which is beneficial to the achieving of these performance factors in a well-balanced manner.

It is preferable that the pneumatic tire of the present technology is applied to a pneumatic tire for use on a light truck, a regular internal pressure of the pneumatic tire being 575 kPa or lower. By applying the pneumatic tire of the present technology to such a tire, when this tire is used and, in particular, when traveling on wet road surfaces in a heavily loaded state, the superior drainage performance and wear resistance performance described above can be demonstrated.

In the present technology, the “tire ground contact width” is the length in the tire width direction between the end portions (ground contact edges) when the tire is mounted on a regular rim and inflated to a regular internal pressure, and placed vertically upon a flat surface with a regular load applied thereto. “Regular rim” is a rim defined by a standard for each tire according to a system of standards that includes standards on which tires are based, and refers to a “standard rim” in the case of Japan Automobile Tyre Manufacturers Association (JATMA), refers to a “design rim” in the case of Tire and Rim Association (TRA), and refers to a “measuring rim” in the case of European Tyre and Rim Technical Organisation (ETRTO). “Regular internal pressure” is the air pressure defined by standards for each tire according to a system of standards that includes standards on which tires are based, and refers to a “maximum air pressure” in the case of JATMA, refers to the maximum value in the table of “TIRE ROAD LIMITS AT VARIOUS COLD INFLATION PRESSURES” in the case of TRA, and refers to the “inflation pressure” in the case of ETRTO. “Regular internal pressure” is 180 kPa for a tire on a passenger vehicle. “Regular load” is a load defined by a standard for each tire according to a system of standards that includes standards on which tires are based, and refers to a “maximum load capacity” in the case of JATMA, to the maximum value in the table of “TIRE ROAD LIMITS AT VARIOUS COLD INFLATION PRESSURES” in the case of TRA, and to “LOAD CAPACITY” in the case of ETRTO. “Regular load” corresponds to 88% of the loads described above for a tire on a passenger vehicle.

### BRIEF DESCRIPTION OF DRAWINGS

FIG. 1 is a meridian cross-sectional view of a pneumatic tire according to an embodiment of the present technology.

FIG. 2 is a front view illustrating a tread surface of the pneumatic tire according to an embodiment of the present technology.

FIG. 3 is an enlarged front view illustrating an inner land portion depicted in FIG. 2.

FIG. 4 is an explanatory diagram illustrating a portion extracted from the inner land portion depicted in FIG. 3.

FIG. 5 is an enlarged front view illustrating a block of a pneumatic tire according to another embodiment of the present technology.

FIG. 6 is an enlarged front view illustrating a block of a pneumatic tire according to another embodiment of the present technology.

### DETAILED DESCRIPTION

Embodiments of the present technology are described in detail below with reference to the accompanying drawings.

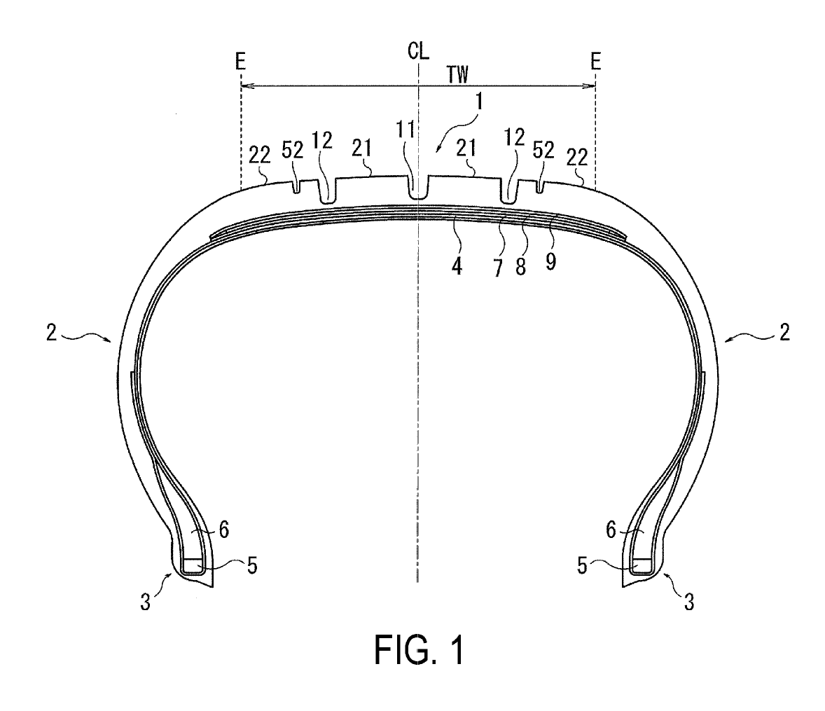

Reference sign CL in FIG. 1 denotes the tire equator. A pneumatic tire T includes a tread portion 1, a side wall portion 2, and a bead portion 3. A carcass layer 4 extends between the left-right pair of bead portions 3. The carcass layer 4 includes a plurality of reinforcing cords extending in a tire radial direction, and is folded back around a bead core 5 disposed in each bead portion 3 from a vehicle inner side to a vehicle outer side. Additionally, bead fillers 6 are disposed on the periphery of the bead cores 5, and each bead filler 6 is enveloped by a main body portion and a folded back portion of the carcass layer 4. In the tread portion 1, a plurality of belt layers 7, 8 (two layers in FIG. 1) are embedded on the outer circumferential side of the carcass layer 4. Each of the belt layers 7, 8 includes a plurality of reinforcing cords inclined with respect to the tire circumferential direction, and the directions of the reinforcing cords of the different layers intersect each other. In the belt layers 7, 8, the inclination angle of the reinforcing cords with respect to the tire circumferential direction is set in the range, for example, of 10° to 40°. In addition, a belt reinforcing layer 9 is disposed on the outer circumferential side of the belt layers 7, 8. The belt reinforcing layer 9 includes organic fiber cords oriented in the tire circumferential direction. In the belt reinforcing layer, the angle of the organic fiber cords with respect to the tire circumferential direction is set, for example, to from 0° to 5°.

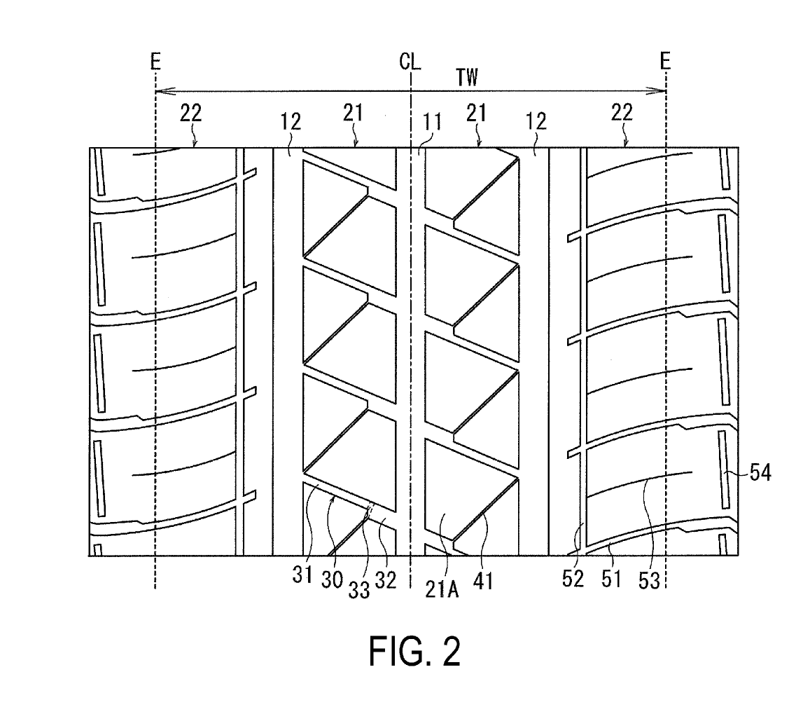

The present technology may be applied to such a general pneumatic tire, however, the cross-sectional structure thereof is not limited to the basic structure described above. As illustrated in FIG. 2, one center main groove 11 extending in the tire circumferential direction is provided on the tire equator CL of the tread portion 1, and one outer main groove 12 extending in the tire circumferential direction is provided on both sides in the tire width direction of the center main groove 11. Additionally, inner land portions 21 extending in the tire circumferential direction are formed partitioned between the center main groove 11 and each of the outer main grooves 12, and outer land portions 22 extending in the tire circumferential direction are formed partitioned outward in the tire width direction from the outer main grooves 12.

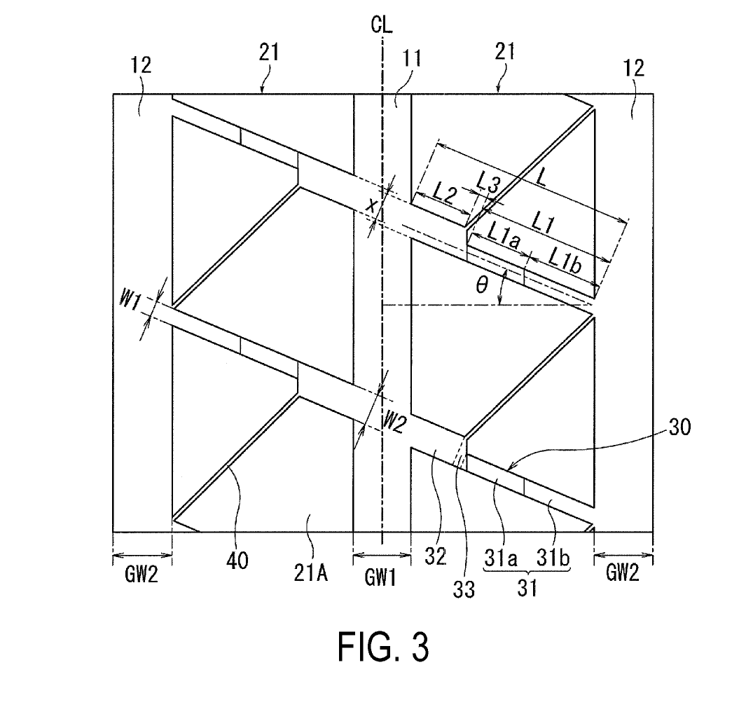

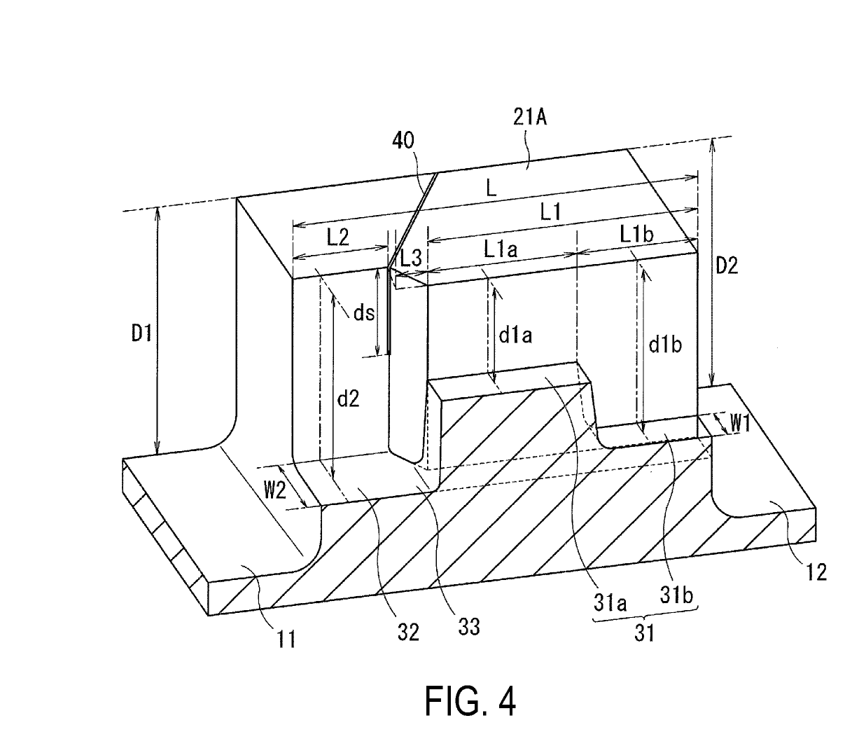

As enlarged and illustrated in FIGS. 3 and 4, a plurality of sub-grooves 30 extending in the tire width direction are formed in the inner land portions 21, at an interval in the tire circumferential direction. A first end of the sub-grooves 30 communicates with the center main groove 11 and a second end communicates with the outer main grooves 12. A groove width of each of the sub-grooves 30 changes at a middle portion in a length direction thereof such that each of the sub-grooves 30 includes a narrow width section 31 positioned on the outer main groove 12 side and having a groove width W1 that is relatively small, and a wide section 32 positioned on the center main groove 11 side and having a groove width W2 that is relatively large. Particularly, in the example illustrated in FIGS. 2 to 4, on the surface of the tread portion 1, the edge of the first side of the sub-groove 30 extends linearly, and the edge of the second side is bent in a step-like shape. As a result, the narrow width section 31 and the wide section 32 are formed. Additionally, in the example illustrated in FIGS. 2 to 4, a change section 33 where the groove width gradually changes is present between the narrow width section 31 and the wide section 32.

Each of the sub-grooves 30 is inclined with respect to the tire width direction. Particularly, a pair of the sub-grooves 30 positioned on both sides of the center main groove 11 is inclined in the same direction with respect to the tire width direction, and disposed such that openings on the center main groove 11 side of the pair of the sub-grooves 30 positioned on both sides of the center main groove 11 at least partially overlap in the tire circumferential direction. Additionally, circumferential components of the sub-grooves 30 are disposed so as to be continuous throughout the entire circumference of the tire.

The inner land portions 21 are divided into a plurality of blocks 21A by these sub-grooves 30. One sipe 40 is provided in each of the blocks 21A. With the sipe 40 provided in each of the blocks 21A, a first end communicates with a point farthest to the narrow width section 31 side of the wide section 32 (in the example illustrated in the drawings, the boundary between the wide section 32 and the change section 33), and a second end communicates with a desired point on the narrow width section 31 (in the example illustrated in the drawings, the point where the narrow width section 31 connects to the outer main groove 12).

In the example illustrated in FIG. 2, a plurality of outer sub-grooves 51 extending in the tire width direction is provided at an interval in the tire circumferential direction in the outer land portions 22. With the outer sub-grooves 51, an end portion on the inner side in the tire width direction does not communicate with the outer main groove 12 and terminates within the outer land portion 22, and an end portion on the outer side in the tire width direction crosses the ground contact edge E and extends outward in the tire width direction. Additionally, one circumferential narrow groove 52 extending in the tire circumferential direction and intersecting the outer sub-groove 51 is provided in each of the outer sub-grooves 51. An outer sipe 53 is provided in a portion partitioned by the outer sub-groove 51 and the circumferential narrow groove 52. The outer sipe 53 is disposed between the outer sub-grooves 51 that are adjacent in the tire circumferential direction and extends in the same direction as the outer sub-grooves 51. With the outer sipe 53, an end portion on the inner side in the tire width direction communicates with the circumferential narrow groove 52, and an end portion on the outer side in the tire width direction crosses the ground contact edge E, extends, and terminates within the outer land portion 22. Additionally, an auxiliary groove 54 that extends in the tire circumferential direction but does not communicate with the outer sub-grooves 51 is provided farther outward in the tire width direction than the end portion on the outer side in the tire width direction of the outer sipe 53. Note that the present technology specifies the structure of the center main groove 11, the outer main grooves 12, and the inner land portions 21 partitioned between the center main groove 11 and the outer main grooves 12. As such, the configuration of the outer land portions 22 is not limited to the structure described above.

As described above, the sub-grooves 30 are provided in the inner land portions 21 positioned on both sides of the center main groove 11. As such, the pair of sub-grooves 30 adjacent across the center main groove 11 are substantially continuous and, as a result, the flow of water passing through the sub-grooves 30 is excellent. Thus, drainage performance can be enhanced and wet performance can be enhanced. Additionally, drainage performance is enhanced and wet performance can be enhanced due to the fact that the circumferential components of the sub-grooves 30 are continuous throughout the entire circumference of the tire and the components of the sub-grooves 30 are constantly present in the ground contact surface during tire rotation. Moreover, each of the sub-grooves 30 includes the narrow width section 31 on the outer main groove 12 side and the wide section 32 on the center main groove 11 side. As a result, drainage performance can be enhanced due to the fact that the wide section 32 is present on the center main groove 11 side and, at the same time, declines in block rigidity can be suppressed due to the narrow width section 31 and, thus, wear resistance can be enhanced. Furthermore, by providing the sipe 40 as described above, the drainage performance of the sipe 40 can be obtained and, at the same time, the rigidity of each of the blocks 21A can be made appropriate, which is beneficial to the achieving of both good wet performance and wear resistance in a compatible manner.

Here, if the openings on the center main groove 11 side of the pair of sub-grooves 30 positioned on both sides of the center main groove 11 are disposed offset in the tire circumferential direction, sufficient drainage performance cannot be obtained. Additionally, in cases where the circumferential components of the sub-grooves 30 are discontinuous throughout the entire circumference of the tire, sufficient drainage performance cannot be obtained.

In the present technology, a total of three main grooves, namely the center main groove 11 and the outer main grooves 12 disposed on both sides of the center main groove 11, are provided in the surface of the tread portion 1. However, if four or more main grooves are provided, the block rigidity will decline and sufficient wear resistance performance cannot be obtained. Particularly, in order to obtain sufficient drainage properties while maintaining block rigidity, it is preferable that a proportion of the total of a groove width GW1 of the center main groove 11 and a groove width GW2 of the outer main grooves 12 (GW1+2×GW2) with respect to a ground contact width TW is in a range of from 13% to 23%. By configuring the total width of the center main groove 11 and the outer main grooves 12 in this manner, block width is secured, sufficient block rigidity is obtained, and wear resistance performance can be enhanced and, at the same time, groove volume is secured and sufficient drainage performance can be obtained. Here, if the total of the groove widths is less than 13% of the ground contact width TW, it will be difficult to obtain sufficient drainage performance; and if the total of the groove widths is greater than 23% of the ground contact width TW, it will be difficult to obtain sufficient block rigidity.

In the present technology, the sub-grooves 30 include the narrow width section 31 and the wide section 32, but it is preferable that a ratio W1/W2 satisfies the relationship 0.30≦W1/W2≦0.70, where W1 is the groove width of the narrow width section 31 and W2 is the groove width of the wide section 32. By configuring the relationship of the groove widths in this manner, a good balance between the groove widths of the narrow width section 31 and the wide section 32 can be achieved, and it is possible to effectively achieve good drainage performance by the wide section 32 and good rigidity maintenance by the narrow width section 31 in a compatible manner. Here, if the ratio W1/W2 is less than 0.30, the difference between the groove widths of the narrow width section 31 and the wide section 32 will be too great and it will be difficult to obtain the advantageous effects described above in a well-balanced manner. If the ratio W1/W2 is greater than 0.70, the difference between the groove widths of the narrow width section 31 and the wide section 32 will be smaller, thus resulting in a configuration equivalent to a configuration where sub-grooves 30 with substantially uniform groove widths are provided. Consequently, the desired advantageous effects from the provision of the narrow width section 31 and the wide section 32 will not be sufficiently obtained. Note that the groove width W2 of the wide section 32 can be set to a range of from 2 mm to 10 mm, for example.

It is preferable that an overlapping amount x of the openings on the center main groove 11 side of the pair of sub-grooves 30 (that is, the openings of the wide sections 32) positioned on both sides of the center main groove 11 is not less than 10% of the groove width (the groove width W2 of the wide section 32). Drainage performance can be further enhanced by sufficiently overlapping the openings on the center main groove 11 side of the pair of sub-grooves 30 positioned on both sides of the center main groove 11 in this manner, such that the pair of sub-grooves 30 positioned on both sides of the center main groove 11 are continuous. Here, if the overlapping amount x is less than 10% of the groove width W2 and the openings of the pair of sub-grooves 30 becomes greatly offset, it will be difficult to sufficiently enhance the drainage performance.

A groove depth of each of the sub-grooves 30 may be constant throughout the entire length of the sub-groove 30, but it is preferable that the groove depth of the narrow width section 31 is relatively shallow on the wide section 32 side and relatively deep on the outer main groove 12 side. By configuring the groove depth of the sub-grooves 30 (the narrow width section 31) in this manner, rigidity at a portion 31a where the groove depth is shallow is increased, which is beneficial to the enhancing of wear resistance, and superior drainage performance can be obtained at a portion 31b where the groove depth is deep, which makes it possible to achieve these performance factors in a well-balanced manner.

Particularly, it is preferable that a ratio d1a/d1b is in a range of from 0.3 to 0.7, where d1a is a groove depth on the wide section 32 side of the narrow width section 31, and d1b is a groove depth on the outer main groove 12 side of the narrow width section 31. By configuring the groove depth in this manner, it is possible to more effectively obtain the effects of achieving good wet performance and wear resistance performance in a compatible manner. Here, if the ratio d1a/d1b of the groove depths is less than 0.3, the difference between the groove depths of the narrow width section 31 and the wide section 32 will be too great and it will be difficult to obtain achieve both drainage performance and wear resistance performance in a well-balanced manner. If the ratio d1a/d1b of the groove depths is greater than 0.7, the configuration will be equivalent to a case where the groove depth is configured to be substantially uniform and, consequently, the desired advantageous effects from varying the groove depth will not be sufficiently obtained.

Furthermore, when d2 is a groove depth of the wide section 32, it is preferable that a ratio d1a/d2 of the groove depth d1a to the groove depth d2 be set in a range of from 0.40 to 0.60 and a ratio d1b/d2 of the groove depth d1b to the groove depth d2 be set in a range of from 0.75 to 0.95. By configuring the relationship between the groove depths in this manner, it is possible to more effectively obtain the effects of achieving good wet performance and wear resistance performance in a compatible manner.

Furthermore, when D1 is a groove depth of the center main groove 11 and D2 is a groove depth of the outer main grooves 12, it is preferable that a ratio d2/D1 of the groove depth d2 to the groove depth D1 be set in a range of from 0.65 to 0.85 and a ratio d1b/D2 of the groove depth d1b to the groove depth D2 be set in a range of from 0.60 to 0.80. By configuring the relationship between the groove depths in this manner, it is possible to more effectively obtain the effects of achieving good wet performance and wear resistance performance in a compatible manner.

With respect to the setting of the groove depths in this manner, it is preferable that the relationships 0.25≦L2/L1≦0.65 and 1.1≦L1a/L1b≦1.5 are satisfied, where L1 is a length of the narrow width section 31, L2 is a length of the wide section 32, L1a is a length of the portion 31a of the narrow width section 31 where the groove depth is d1a, and L1b is a length of the portion 31b in the narrow width section 31 where the groove depth is d1b. Additionally, as illustrated in the examples of FIGS. 2 to 4, in cases where the change section 33 is provided, it is preferable that the relationship 0≦L3/L≦0.15 is satisfied, where L is an entire length of the sub-groove 30 and L3 is a length of the change section 33. By configuring the lengths in this manner, it is possible to more effectively obtain the effects of achieving good wet performance and wear resistance performance in a compatible manner. Note that the lengths L, L1, L2, L3, L1a, and L1b are all lengths of portions, measured along the length direction of the sub-groove 30, as illustrated in FIGS. 3 and 4.

An angle of inclination θ of each of the sub-grooves 30 with respect to the tire width direction is preferably from 10° to 50°, and more preferably is set in a range of from 15° to 40°. By configuring the angle of inclination θ of the sub-grooves 30 in this manner, corner portions of the blocks 21A where the sub-grooves 30 and the center main groove 11 or the outer main grooves 12 communicate can be prevented from becoming excessively acute, which is beneficial to the enhancing of wear resistance. Here, if the angle of inclination θ is smaller than 10°, the sub-grooves 30 will substantially extend along the tire width direction, and it will be difficult to cause the sub-grooves 30 to be continuous throughout the entire circumference of the tire. If the angle of inclination θ is larger than 50°, acute portions will be formed in the corner portion of the blocks 21A, and it will be difficult to enhance wear resistance.

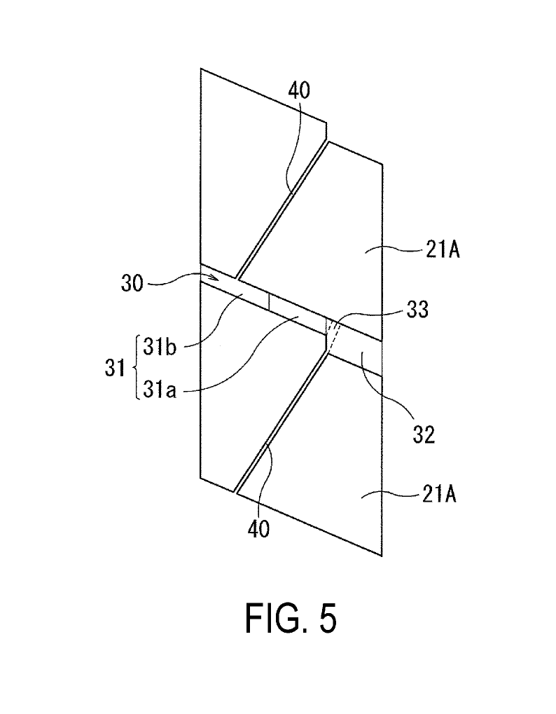

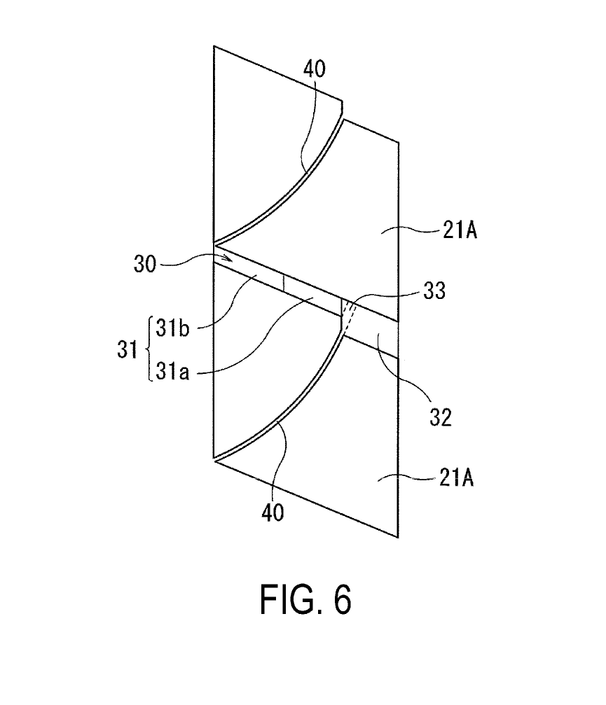

The end portion on the side of the sipe 40 communicating with the narrow width section 31 can be connected to any point of the narrow width section 31. As such, a configuration is possible in which this end portion is connected to a point where the narrow width section 31 connects to the outer main groove 12, as illustrated in FIGS. 2 and 3; and also a configuration is possible in which this end portion communicates with a middle portion of the narrow width section 31, as illustrated in FIG. 5. Additionally, as illustrated in FIG. 6, a configuration is possible in which the sipe 40 is curved so as to form an arc protruding inward in the tire width direction in the surface of the tread portion 1 (the block 21A).

In the present technology, the sipe 40 is a fine groove for which the groove width and the groove depth are sufficiently smaller than those of the main grooves (the center main groove 11 and the outer main grooves 12). For example, the sipe 40 may have a groove width of from 0.4 mm to 1.5 mm. Additionally, a depth ds of the sipe 40 is configured to be smaller than the depth d2 of the wide section 32 with which the first end of the sipe 40 communicates. A ratio ds/d2 of the depth ds of the sipe 40 to the depth d2 of the wide section 32 is preferably set in a range of from 0.3 to 0.8. Configuring the sipe depth in this manner is beneficial to achieving drainage performance and wear resistance performance in a compatible manner.

It is preferable that the various features of the present technology described above are applied to a pneumatic tire for use on a light truck, a regular internal pressure of the pneumatic tire being 575 kPa or lower. With such a pneumatic tire for use on a light truck, when traveling on wet road surfaces in a heavily loaded state, the load on the blocks increases and, not only is wear more likely to occur in the entire tire but, also, there is a tendency for the groove volume to decrease due to the blocks deforming and the grooves collapsing, which leads to declines in drainage performance. However, by applying the features of the present technology described above, the superior drainage performance and wear resistance performance described above can be exhibited, particularly when traveling on wet road surfaces in a heavily loaded state.

### EXAMPLES

Thirty types of pneumatic tires were fabricated for Conventional Example 1, Comparative Example 1, and Examples 1 to 28. These tires had a tire size of 235/60R17, the cross-sectional shape illustrated in FIG. 1, and the basic tread pattern illustrated in FIG. 2. The number of main grooves, the total of the groove widths of the main grooves, whether or not the circumferential components of the sub-grooves were continuous throughout the entire circumference of the tire, the overlapping amount x of the openings on the center main groove side of the pair of sub-grooves positioned on both sides of the center main groove (proportion of the wide section with respect to the groove width W2), the ratio W1/W2 of the groove width W1 of the narrow width section to the groove width W2 of the wide section, the ratio d1a/d1b of the groove depth d1a on the wide section side of the narrow width section to the groove depth d1b on the outer main groove side of the narrow width section, the ratio d1a/d2 of the groove depth d1a on the wide section side of the narrow width section to the groove depth d2 of the wide section, the ratio d2/D1 of the groove depth d2 of the wide section to the groove depth D1 of the center main groove, the ratio d1b/D2 of the groove depth d1b on the outer main groove side of the narrow width section to the groove depth D2 of the outer main groove, the ratio L1/L2 of the length L1 of the narrow width section to the length L2 of the wide section, the ratio L1a/L1b of the length L1a of the portion of the narrow width section where the groove depth is d1a to the length L1b of the portion of the narrow width section where the groove depth is d1b, the ratio L3/L of the total length L of the sub-groove to the length L3 of the change section where the groove width changes, and the ratio ds/d2 of the groove depth ds of the sipe to the groove depth of the wide section d2 were configured as shown in Tables 1 and 2.

Conventional Example is an example in which five land portions are partitioned by four main grooves (two on each side of the tire equator) and, as such, the basic structure of the tread pattern is different. However, for the sake of convenience, this structure is considered to include the center main groove of the present technology as the main grooves on the tire equator side, the inner land portions of the present technology as land portions partitioned between the main grooves on the tire equator side and the main grooves outward in the tire width direction, and the outer land portions of the present technology as land portions partitioned outward in the tire width direction of the main grooves outward in the tire width direction. Thus, the dimensions and the like of each constituent was defined. Here, the land portion formed between the pair of main grooves on the tire equator side was a rib-like land section extending continuously in the tire circumferential direction. From a different perspective, Conventional Example 1 is an example using the tread pattern of FIG. 2, in which the groove width of the center main groove is widened and a rib-like land section is added at a center thereof (on the tire equator). Note that with the Conventional Example 1, the number of main grooves differs from the other examples, but is configured such that the total of the groove widths of the main grooves is made approximately the same as the other examples (e.g. the same as

Comparative Example 1) by adjusting (narrowing) the groove width of each of the main grooves.

These 30 types of pneumatic tires were evaluated for wet performance and wear resistance performance by the evaluation methods described below, and the results thereof are also shown in Tables 1 and 2.

### Wet Performance

The test tires were assembled on wheels with a rim size of 16×7.0, inflated to an air pressure of 475 kPa, and mounted on a test vehicle having an engine displacement of 2700 cc. Braking distance was measured from a state of driving at an initial speed of 100 km/h on a test course with a wet road surface having a water depth of 10±1 mm. The evaluation results were expressed as index values using the inverse of the measurement values, with Conventional Example 1 being assigned a reference index value of 100. Larger index values indicate shorter braking distance and superior wet performance.

### Wear Resistance Performance

The test tires were assembled on wheels with a rim size of 16×7.0, inflated to an air pressure of 475 kPa, and mounted on a test vehicle having an engine displacement of 2700 cc. The amount of wear was measured after traveling 50,000 km at an average speed of 60 km/h. The evaluation results were expressed as index values using the inverse of the measurement values, with Conventional Example 1 being assigned a reference index value of 100. Larger index values indicate superior wear resistance.

TABLE 1

| | | | Conventional | Comparative | | | | |
|---|---|---|---|---|---|---|---|---|
| | | | Example 1 | Example 1 | Example 1 | Example 2 | Example 3 | Example 4 |
| Main | Number | (grooves) | 4 | 3 | 3 | 3 | 3 | 3 |
| grooves | Total of groove widths | % | 12 | 12 | 17 | 13 | 23 | 17 |
| Sub- | Circumferential components | | Discontinuous | Discontinuous | Continuous | Continuous | Continuous | Continuous |
| groove | Overlapping amount x | % | 0 | 0 | 90 | 90 | 90 | 10 |

| | | | | | | | |
|---|---|---|---|---|---|---|---|
| | Angle of inclination θ | 55 | 55 | 26 | 26 | 26 | 26 |
| | Ratio W1/W2 | 0.50 | 0.50 | 0.50 | 0.50 | 0.50 | 0.50 |
| | Ratio d1a/d1b | 1.00 | 1.00 | 0.55 | 0.55 | 0.55 | 0.55 |
| | Ratio d1a/d2 | 0.80 | 0.80 | 0.50 | 0.50 | 0.50 | 0.50 |
| | Ratio d2/D1 | 0.80 | 0.80 | 0.75 | 0.75 | 0.75 | 0.75 |
| | Ratio d1b/D2 | 0.64 | 0.64 | 0.68 | 0.68 | 0.68 | 0.68 |
| | Ratio L2/L1 | 0.45 | 0.45 | 0.45 | 0.45 | 0.45 | 0.45 |
| | Ratio L1a/L1b | — | — | 1.3 | 1.3 | 1.3 | 1.3 |
| | Ratio L3/L | 0.75 | 0.75 | 0.75 | 0.75 | 0.75 | 0.75 |
| Sipe | Communicating location | FIG. 3 | FIG. 3 | FIG. 3 | FIG. 3 | FIG. 3 | FIG. 3 |
| | Ratio ds/d2 | 0.55 | 0.55 | 0.55 | 0.55 | 0.55 | 0.55 |

| | | | | | | | |
|---|---|---|---|---|---|---|---|
| Wet performance | index value | 100 | 97 | 107 | 103 | 109 | 104 |
| Wear resistance performance | index value | 100 | 103 | 106 | 107 | 102 | 106 |

| | | | Example 5 | Example 6 | Example 7 | Example 8 | Example 9 | Example 10 | Example 11 |
|---|---|---|---|---|---|---|---|---|---|
| Main | Number | (grooves) | 3 | 3 | 3 | 3 | 3 | 3 | 3 |
| grooves | Total of groove widths | % | 17 | 17 | 17 | 17 | 17 | 17 | 17 |
| Sub- | Circumferential components | | Continuous | Continuous | Continuous | Continuous | Continuous | Continuous | Continuous |
| groove | Overlapping amount x | % | 100 | 90 | 90 | 90 | 90 | 90 | 90 |

| | | | | | | | | |
|---|---|---|---|---|---|---|---|---|
| | Angle of inclination θ | 26 | 10 | 15 | 40 | 50 | 26 | 26 |
| | Ratio W1/W2 | 0.50 | 0.50 | 0.50 | 0.50 | 0.50 | 0.30 | 0.70 |
| | Ratio d1a/d1b | 0.55 | 0.55 | 0.55 | 0.55 | 0.55 | 0.55 | 0.55 |
| | Ratio d1a/d2 | 0.50 | 0.50 | 0.50 | 0.50 | 0.50 | 0.50 | 0.50 |
| | Ratio d2/D1 | 0.75 | 0.75 | 0.75 | 0.75 | 0.75 | 0.75 | 0.75 |
| | Ratio d1b/D2 | 0.68 | 0.68 | 0.68 | 0.68 | 0.68 | 0.68 | 0.68 |
| | Ratio L2/L1 | 0.45 | 0.45 | 0.45 | 0.45 | 0.45 | 0.45 | 0.45 |
| | Ratio L1a/L1b | 1.3 | 1.3 | 1.3 | 1.3 | 1.3 | 1.3 | 1.3 |
| | Ratio L3/L | 0.75 | 0.75 | 0.75 | 0.75 | 0.75 | 0.75 | 0.75 |
| Sipe | Communicating location | FIG. 3 | FIG. 3 | FIG. 3 | FIG. 3 | FIG. 3 | FIG. 3 | FIG. 3 |
| | Ratio ds/d2 | 0.55 | 0.55 | 0.55 | 0.55 | 0.55 | 0.55 | 0.55 |

| | | | | | | | | |
|---|---|---|---|---|---|---|---|---|
| Wet performance | index value | 108 | 102 | 105 | 108 | 109 | 105 | 108 |
| Wear resistance performance | index value | 106 | 108 | 107 | 103 | 101 | 107 | 104 |

TABLE 2

| | | | Example 12 | Example 13 | Example 14 | Example 15 | Example 16 | Example 17 | Example 18 |
|---|---|---|---|---|---|---|---|---|---|
| Main | Number | (grooves) | 3 | 3 | 3 | 3 | 3 | 3 | 3 |
| grooves | Total of groove widths | % | 17 | 17 | 17 | 17 | 17 | 17 | 17 |
| Sub- | Circumferential components | | Continuous | Continuous | Continuous | Continuous | Continuous | Continuous | Continuous |
| groove | Overlapping amount x | % | 90 | 90 | 90 | 90 | 90 | 90 | 90 |

| | | | | | | | | |
|---|---|---|---|---|---|---|---|---|
| | Angle of inclination θ | 26 | 26 | 26 | 26 | 26 | 26 | 26 |
| | Ratio W1/W2 | 0.50 | 0.50 | 0.50 | 0.50 | 0.50 | 0.50 | 0.50 |
| | Ratio d1a/d1b | 0.30 | 0.40 | 0.60 | 0.70 | 0.55 | 0.55 | 0.55 |
| | Ratio d1a/d2 | 0.40 | 0.45 | 0.55 | 0.60 | 0.50 | 0.50 | 0.50 |
| | Ratio d2/D1 | 0.65 | 0.70 | 0.80 | 0.85 | 0.75 | 0.75 | 0.75 |
| | Ratio d1b/D2 | 0.87 | 0.79 | 0.73 | 0.73 | 0.68 | 0.68 | 0.68 |
| | Ratio L2/L1 | 0.45 | 0.45 | 0.45 | 0.45 | 0.25 | 0.65 | 0.45 |
| | Ratio L1a/L1b | 1.3 | 1.3 | 1.3 | 1.3 | 1.3 | 1.3 | 1.1 |
| | Ratio L3/L | 0.75 | 0.75 | 0.75 | 0.75 | 0.75 | 0.75 | 0.75 |
| Sipe | Communicating location | FIG. 3 | FIG. 3 | FIG. 3 | FIG. 3 | FIG. 3 | FIG. 3 | FIG. 3 |
| | Ratio ds/d2 | 0.55 | 0.55 | 0.55 | 0.55 | 0.55 | 0.55 | 0.55 |

| | | | | | | | | |
|---|---|---|---|---|---|---|---|---|
| Wet performance | index value | 105 | 106 | 108 | 109 | 105 | 109 | 108 |
| Wear resistance performance | index value | 103 | 105 | 107 | 108 | 108 | 104 | 105 |

| | | | Example 19 | Example 20 | Example 21 | Example 22 | Example 23 | Example 24 |
|---|---|---|---|---|---|---|---|---|
| Main | Number | (grooves) | 3 | 3 | 3 | 3 | 3 | 3 |
| grooves | Total of groove widths | % | 17 | 17 | 17 | 17 | 17 | 17 |
| Sub- | Circumferential components | | Continuous | Continuous | Continuous | Continuous | Continuous | Continuous |
| groove | Overlapping amount x | % | 90 | 90 | 90 | 90 | 90 | 90 |

| | | | | | | | |
|---|---|---|---|---|---|---|---|
| | Angle of inclination θ | 26 | 26 | 26 | 26 | 26 | 26 |
| | Ratio W1/W2 | 0.50 | 0.50 | 0.50 | 0.50 | 0.50 | 0.50 |
| | Ratio d1a/dlb | 0.55 | 0.55 | 0.55 | 0.55 | 0.55 | 0.55 |
| | Ratio d1a/d2 | 0.50 | 0.50 | 0.50 | 0.50 | 0.50 | 0.50 |
| | Ratio d2/D1 | 0.75 | 0.75 | 0.75 | 0.75 | 0.75 | 0.75 |
| | Ratio d1b/D2 | 0.68 | 0.68 | 0.68 | 0.68 | 0.68 | 0.68 |
| | Ratio L2/L1 | 0.45 | 0.45 | 0.45 | 0.45 | 0.45 | 0.45 |
| | Ratio L1a/L1b | 1.5 | 1.3 | 1.3 | 1.3 | 1.3 | 1.3 |
| | Ratio L3/L | 0.75 | 0 | 1.5 | 0.75 | 0.75 | 0.75 |
| Sipe | Communicating location | FIG. 3 | FIG. 3 | FIG. 3 | FIG. 6 | FIG. 3 | FIG. 3 |
| | Ratio ds/d2 | 0.55 | 0.55 | 0.55 | 0.55 | 0.30 | 0.80 |

| | | | | | | | |
|---|---|---|---|---|---|---|---|
| Wet performance | index value | 106 | 106 | 106 | 107 | 106 | 107 |
| Wear resistance performance | index value | 107 | 105 | 105 | 106 | 106 | 105 |

As is clear from Tables 1 and 2, each of the Examples 1 to 24 exhibited wet performance and wear resistance performance that was enhanced in a well-balanced manner compared to Conventional Example 1. On the other hand, in Comparative Example 1, the number of main grooves was less than in Conventional Example 1 and, as a result, while wear resistance performance was enhanced, the circumferential components of the sub-grooves were not continuous throughout the entire circumference, the overlapping amount x was 0, and the pair of sub-grooves positioned on both sides of the center main groove were not continuous and, thus, wet performance declined.

1. A pneumatic tire, comprising:
one center main groove extending in a tire circumferential direction on a tire equator of a tread portion;
one outer main groove extending in the tire circumferential direction on both sides in a tire width direction of the center main groove;
inner land portions formed partitioned between the center main groove and the outer main grooves;
a plurality of sub-grooves formed at an interval in the tire circumferential direction and extending in the inner land portions in the tire width direction, for which a first end communicates with the center main groove and a second end communicates with the outer main groove;
the inner land portions being divided into a plurality of blocks by the plurality of sub-grooves; wherein
a pair of the sub-grooves positioned on both sides of the center main groove is inclined in a same direction with respect to the tire width direction, and disposed such that openings on a side of the center main groove at least partially overlap in the tire circumferential direction;
the sub-grooves are disposed such that circumferential components of the sub-grooves are continuous throughout an entire circumference of the tire;
a groove width of each of the sub-grooves changes at a middle portion in a length direction of the sub-grooves such that each of the sub-grooves includes a narrow width section positioned on a side of the outer main groove and having a groove width W1 that is relatively small, and a wide section positioned on the side of the center main groove and having a groove width W2 that is relatively large;
a groove depth of the narrow width section is shallow on a side of the wide section and deep on a side of the outer main groove; and
a sipe is formed in each block that connects a point closest to a side of the narrow width section of the wide section to the narrow width section.

2. The pneumatic tire according to claim 1, wherein:
an angle of inclination of the sub-grooves with respect to the tire width direction is from 10° to 50°.

3. (canceled)

4. The pneumatic tire according to claim 1, wherein:
a ratio d1a/d1b of a groove depth d1a on the side of the wide section of the narrow width section to a groove depth d1b on the side of the outer main groove of the narrow width section is in a range of from 0.3 to 0.7.

5. The pneumatic tire according to claim 1, wherein:
a proportion of a total of groove widths of the center main groove and the outer main grooves with respect to a ground contact width is from 13% to 23%.

6. The pneumatic tire according to claim 1 that is applied to a pneumatic tire for use on a light truck, a regular internal pressure of the pneumatic tire being 575 kPa or lower.

7. The pneumatic tire according to claim 4, wherein:
a proportion of a total of groove widths of the center main groove and the outer main grooves with respect to a ground contact width is from 13% to 23%.

8. The pneumatic tire according to claim 2, wherein:
a proportion of a total of groove widths of the center main groove and the outer main grooves with respect to a ground contact width is from 13% to 23%.
